(19) United States
(12) Patent Application Publication
(10) Pub. No.: US 2017/0323258 A1
(43) Pub. Date: Nov. 9, 2017

(54) METHOD FOR TRANSMITTING PERISHABLE SHIPMENTS

(71) Applicant: Continental Automotive GmbH, Hannover (DE)

(72) Inventor: Akos SEMSEY, Regensburg (DE)

(21) Appl. No.: 15/528,234

(22) PCT Filed: Nov. 19, 2015
(86) PCT No.: PCT/EP2015/077094

§ 371 Date: May 19, 2017

(30) Foreign Application Priority Data
Nov. 21, 2014 (DE) 10 2014 223 769.6

(51) Int. Cl. G06Q 10/08; G08G 1/14; G01C 21/20; H04L 9/32; H04W 12/06

(52) U.S. Cl. CPC G06Q 10/0832; G08G 1/144; G01C 21/20; H04W 12/06; H04L 9/3271

(57) ABSTRACT

A method for transmitting perishable shipments in vehicles, including: a first communications module (M1) for establishing a communication connection to a communications terminal of a supplier which receives authorization data via a communications network (N1); a first identification routine for clearly identifying a supplier; a second communications module (M2) for establishing a communication connection via a wireless communications network (N2) to a communication device of a control device of the access assembly of a vehicle; a second identification routine for clearly identifying the system by the access assembly; a third communications module (M3) for receiving update request information from the driver; and an update routine for updating authorization data in a memory of the system.

### BACKGROUND

The present invention relates to a method for transferring perishable consignments.

Delivery services that have to transfer perishable consignments expend a large amount of effort in getting from one delivery address to another, resulting in the expenditure of a large amount of time and in travel profiles that are quite unfavorable for the delivery vehicles.

The term perishable consignment is understood to mean, predominantly, foodstuffs that are refrigerated and frozen goods, and that are derived from animals and plants. Foodstuffs can rapidly lose quality at normal temperatures, with over-ripeness, wilting, mold, rot, loss of aroma and vitamins, rancidity and formation of toxic substances representing typical changes that, within a short time, impairs the edibility of foodstuffs or renders them inedible. They are therefore designated as easily perishable foodstuffs. Their preservability, quality and freshness can be maintained over a longer period by use of refrigeration or freezing.

A postal recipient of a consignment is the person who is known at the address and for whom a (postal) consignment is intended. The person may be a natural or a legal person, e.g. an institution, a corporate body or a company. A residential address is the postal address of a residence at which a person permanently resides. This may be the main residence or the secondary residence. A residential address normally consists of the specification of the street, the house number, the city/town and the country. In some cases, the apartment or room number, or the floor, the part of the building (e.g. rear building) and a sub-tenancy (“at” or “c/o”) is/are also specified. For the dispatch of perishable consignments (postal consignments), the residential address also includes the postcode/zip code and, where appropriate, the district of the city or town. If the residential address is located in a residential estate, the name of the estate is specified, together with the house number, instead of specification of the street.

A postal recipient is also understood to be the person who actually takes delivery of a postal consignment. This person may be, but need not be, the addressee. The person may be instructed by the recipient to take delivery of the postal consignment. Postal consignments are usually placed in the house letterbox. Particular consignments such as, for example, those of the consignment type “by registered letter” or “notice of delivery” are generally handed over directly to the recipient, as are telegrams and express consignments. Some consignments, e.g. packets that cannot be handed over, are not put into the letterbox. In these cases, the recipient receives a notification card.

It is frequently the case that the person concerned is not to be found at the residential address at the time of delivery, and a notification, already mentioned, is left by a postal or delivery service, concerning how, where and when the consignment can be delivered again. This inefficient logistics results in additional environmental impact and costs because, for example, the engines in the delivery vehicles are often used outside of the optimal working range. Furthermore, the delivery vehicles are often a traffic obstruction, because the drivers seldom find a parking space for the short stopping times, but simply stop with warning indicators, and it is necessary to go several times to the residential address to hand over the consignments.

Vehicles are now frequently equipped with so-called “keyless-entry access units”, which enable the vehicle to be unlocked/locked from the outside by radio communication. This requires a control unit, located in the motor vehicle, that communicates by means of radio signals with an external unit, which is integrated, at least, in a key or in an authorization card for the vehicle. The control unit located in the vehicle, and the external unit, also called an external identification unit, that the driver usually carries on their person, go into radio contact after both have been activated. The two units then exchange data, containing a stored code, via radio communication. If this code matches between the identification unit and the control unit, the vehicle is unlocked or locked by the authorized driver.

The perishable consignments are usually transferred to the residential address of the person concerned, as performed, for example, by delivery services. A recipient of a perishable consignment is the person who is known at the address and for whom a (postal) consignment is intended. The person in this case may be a natural or legal person, e.g. an institution, a corporate body or a company.

### BRIEF SUMMARY

The object of the invention is to provide the delivery of perishable consignments with a lesser logistics resource requirement.

The object is achieved by the features of the method according to the invention as claimed in claim 1.

In an advantageous design of the method according to the invention for transferring perishable consignments into vehicles, there are effected the determination of the position of the vehicle, by means of a positioning system in the vehicle, and the clearance of a position of the parked vehicle, as a delivery address, to a system, via a communications unit of the vehicle, via a communications network. After this, there are effected the transmission of the position of the parked vehicle, via a communications unit of a control device of the access arrangement, via a communications network, and then the transmission of the authorization clearance for opening at least one door and/or trunk of the vehicle by a person delivering a consignment, via a communications means of a system, via a communications network, to the communications terminal device of the person delivering a consignment, and the radio signal contains the authorization clearance, wherein the opening is valid within a defined time window.

There is then effected the transmission of a radio signal, which contains an authorization clearance, wherein, upon authorization being present, the access arrangement activates opening of at least one door and/or trunk of the vehicle and, after opening and transferral of the consignment have been completed by the manual closing of a door and/or trunk of the vehicle by the delivery person, that a confirmation of the transferral of the consignment by the delivery person is effected via the communications means, via the communications network, to the communications terminal device of the driver of the vehicle via the system and, following transmission of an update request by the communications means of the driver of the vehicle, an update of authorization data is effected in the control device of the access arrangement, are performed. Upon the clearance of the position of the vehicle, by the driver, as a delivery address, it is specified by the driver what type of perishable consignment in the vehicle is to be delivered and, following opening and transferral of the perishable consignment into the trunk, an energy source in the vehicle, which serves to supply a refrigeration unit, in which the perishable consignment is delivered, is suitable, is activated. If the perishable consignment is to be cooled in a low temperature range, checking of the vehicle type is performed, by the previously upon the clearance of the position of the vehicle as a delivery address that was specified by the driver, whether such an energy source is present in the vehicle.

Perishable consignments are foodstuffs, and are generally not germ-free, but contain wanted microorganisms such as, for example, lactic acid bacteria and culture molds, or unwanted germs. Particularly animal products, but also vegetable products, are frequently contaminated with spoilage bacteria, or also with pathogens such as, for example, salmonella.

Foodstuff infections and food poisonings can be largely avoided by adherence to defined refrigeration regulations. These measures are intended either to kill bacteria and mold fungi, or to impede their multiplication, their growth, or the formation of toxic metabolites.

Although bacteria cannot be seen, smelled or tasted, their presence must always be taken into account. The danger in this case lies, not necessarily in the germ colonization, but particularly in the fact that they can multiply very rapidly in foodstuffs and on objects, even at room temperatures.

Under ideal conditions, one million germs can be produced from one bacterium within 5 hours, by cell division. Some mold fungi form toxic metabolites on foodstuffs.

Common to highly perishable foodstuffs is their high water content, which, relative to the total mass of a product, is usually greater than 70->90%. Owing to their high water content, these products give off water vapor to the atmosphere of the store. They include vegetable products, e.g. bananas, pineapples, citrus fruits, pome and stone fruit, berry fruit, vegetables, potatoes and onions, and animal products, e.g. meat, fish, eggs, fats and cheese. In the case of fruits and plant parts that have been separated from their parent plant, decomposition processes occur predominantly. There is consequently no supply of new nutrients. The respiration processes must be selectively controlled (e.g. “sleeping temperatures”), and they therefore require a conditioned temperature, humidity and ventilation, with intensive ventilation being required. The term temperature-controlled transport is used. For some plants, the creation of a controlled atmosphere is even more favorable.

According to the invention, the refrigeration containers used in transferral by the delivery service have a required supply of fresh air, if storage over a prolonged period of time in transferral by the delivery service has been notified, and a specific cargo care is required, such as, for example, by a thermally insulated refrigerated container having a temperature-controlled atmosphere, i.e. that can be cooled or heated, and by CA containers. They are completely closed off from the outside air. The controlled atmosphere enables the preservability of fruit and vegetables to be increased in some cases in comparison with normal refrigerated transports and, in the case of connection to the energy source in the vehicle, a very long preservability can be achieved as a result.

Meat and fish also belong in this group, and are usually transported in refrigerated containers, at minus temperatures. In order to avoid losses of mass, associated with drying of the surfaces, high relative humidities are advantageous, which can be provided in a favorable manner by the delivery service according to the invention.

Newer refrigerated container units have the technical prerequisites for regulated humidification of the cooling air in the plus temperature range. In the minus range, this is not a possibility. The humidity of the cooling air in the frost range depends significantly on the temperature difference between the cooling air (return air) and an evaporator. How cold an evaporator has to be in order to cool the cooling air to a particular temperature, depends, in turn, on its size, such as, for example, the smaller the evaporator surface, the lower the temperature, and vice versa. This circumstance then determines what refrigerating container can be used in the vehicle in the first place, and what maximum refrigeration period is achieved in the case of connection to the energy source in the vehicle. Furthermore, the humidity is influenced by the quantity of evaporating frozen water. Since meat and fish usually arrive for loading in virtually vapor-tight packagings, the amount of sublimated humidity will be very small. The dimensions of the evaporator are defined by its structure, and thus there is no possibility of influencing the humidity at minus temperatures. Since, for this reason, the optimum humidity cannot always be achieved, it is all the more important to package the products in, for example, vapor-tight foils, in order to avoid losses of mass and drying out.

Quite generally, it may be stated that, in order to solve the problem, an approach is proposed in which the trunk of the vehicle or a part thereof is refrigerated or ventilated, if a perishable consignment has taken place in the trunk. The delivery of the product is registered by the control device in the vehicle, which control device issues the access authorization to the trunk. This may be used as a trigger criterion for the refrigeration/ventilation.

Quite generally, there are the possibilities for refrigeration/ventilation by the simplest solution of activating, in the trunk, a connection that has the vehicle system voltage, which serves as an energy source for the refrigerating containers. There are vehicles that already have this socket for the refrigerating box, but the switching thereof is fixedly connected to the ignition, radio position. In contrast to this, the automatic switching is connected to the product delivery and, when the vehicle receives a delivery, the socket in the trunk is activated. Advantageously, the energy consumption is monitored, and the socket is switched off if the energy source of the vehicle goes below a certain energy quantity. It is thereby possible to avoid a situation in which the vehicle can no longer be started.

A further cost-optimized solution is the simple ventilation of the vehicle in summer by a fan that is built into the air-conditioning system. According to the invention, it is conceivable to effect ventilation of the trunk by means of a built-in fan dedicated for this purpose. This fan must also be activated in connection with the delivery, and possibly deactivated or limited, depending on the state of the energy source. Regulation or switch-off that is dependent on the energy capacity state serves to ensure that the vehicle is able to start if the energy capacity should be insufficient to maintain the refrigeration/ventilation over a prolonged period.

A further solution variant, in the case of electric or plug-in hybrid vehicles, would be to effect activation of the air-conditioning system from the driving energy source, or even from the charging infrastructure if the vehicle happens to be connected to the charging infrastructure.

The method according to the invention also makes it possible to place the perishable consignment in the passenger compartment, and not in the trunk, if a temperature range of from 10° C.-20° C. were permissible for hour-based storage of the perishable consignment, since cooling by the air-conditioning system of the vehicle would also thereby be sufficient.

Advantageously, it is common to all solutions that the delivered consignments do not lose quality in the trunk as a result of overheating.

In another advantageous design of the method according to the invention, the activation of the energy source is effected via a control device of the access arrangement.

In another advantageous design of the method according to the invention, upon the actuation of the energy source via the control device of the access arrangement, a switching is effected to check the voltage of the energy source and, in the case of a value below a minimum energy capacity value that is necessary, at least, for starting the vehicle, the energy source is switched off, and the driver receives a message, by the vehicle-driver communications means, concerning the switch-off of the energy source.

In another advantageous design of the method according to the invention, it is ascertained, in the checking of the vehicle type, what quantity of energy there is in the vehicle.

Plug-in hybrids and electric vehicles are particularly suitable for refrigeration/ventilation of delivered perishable consignments described in the invention, because, firstly, they can store considerable electrical energy in the drive energy source and, secondly, when parked they can be connected to external energy sources for charging the driving energy source. The possible energy quantity, and consequently the duration of refrigeration/ventilation of the trunk or passenger compartment is therefore considerably greater than in the case of vehicle types driven only by an internal combustion engine.

Another advantageous design of the method according to the invention is characterized in that, in the checking of the vehicle type, it is ascertained whether the vehicle is a hybrid vehicle or an electrically driven vehicle.

Another advantageous design of the method according to the invention is characterized in that it is ascertained whether the vehicle is connected to an external charging source and, if there is a connection to the external charging source, the connection for checking the checking the energy capacity is switched off.

In an advantageous design, the notification of the delivery may be effected in that the vehicle, via the communications means transmits an SMS, email or other electronic message, as a data packet, to the driver via the communications network N2, to the communications terminal, concerning the successful delivery, or deliveries not effected, within the predefined time window. When the driver opens the vehicle, the driver receives, via the access arrangement, a short message, which is represented acoustically or visually on the display screen of the communications terminal, that a new delivery was received or a package was collected at a particular time. If it is output that a delivery has been effected, it is envisaged according to the invention that a warning be emitted upon exit from the vehicle if, for example, there are still delivered goods in the trunk. This is intended to remind the driver, when leaving the vehicle, not to forget the delivered goods in the vehicle.

In another advantageous design, the confirmation of the effected delivery is effected in that the vehicle, following a delivery and the closure of the trunk or the doors, issues a confirmation to the system to signal that the vehicle is again closed. If the vehicle is not locked again within a period of time, the communications device of the delivery person receives a warning message, via the system, that the vehicle is not properly closed.

It is envisaged according to the invention that a visual, acoustic, sensory documentation of the delivery be effected by means on an on-board camera. For this purpose, it is envisaged that, when the vehicle is opened, the cameras present in the vehicle, which are built into the vehicle for these and other purposes, take photographs or make video recordings, and are triggered by the access arrangement. It is also envisaged that there are built-in cameras in the trunk.

Particularly advantageous is the use of cameras that are built in for blind-spot detection, parking assistance, support of adaptive restraint system, sleep warning systems or other purposes, and that are operated by the access arrangement when the trunk or the doors are opened. The video films or photographs can avoid or clarify possible instances of misuse. Sensor values from acceleration sensors or so-called acoustic emission sensors or microphone signals are likewise used for the purpose of documenting the completed transfer of the consignment.

In another advantageous design, the position of at least one free parking space is calculated, based on a vehicle-to-vehicle and/or vehicle-to-infrastructure communication, from the current position of the vehicle, and transmitted to a navigation device of the vehicle. The navigation device in this case may transmit the position to the system via the communications means.

Another design of the method according to the invention is characterized in that the position of the free parking space is transmitted to the navigation device when the vehicle is located in a previously defined region in relation to the free parking space, preferably in the proximity of a barrier of a parking facility.

A very advantageous design is characterized in that, following parking of the vehicle in a selected free parking space, the position of the selected parking space is transmitted to a memory medium that preferably can be transported by the driver, preferably to a key of the vehicle and/or to a mobile telephone of the driver and/or to a chip card, then stored, and preferably additionally displayed, on the memory medium.

An advantageous design is characterized in that the navigation device or the memory medium transmits the position of the selected parking space to the system via a parking-space management system of the parking facility.

In another design, upon departure from the selected parking space, the position of the parking space that is now free again is transmitted to the system via the parking-space management system of the parking facility.

In another advantageous design, the position of the at least one free parking space is calculated from a measurement of distance, of at least one vehicle or at least one infrastructure element in relation to other vehicles or in relation to other infrastructure elements, that are disposed within a surrounding area having a predefined radius around the vehicle searching for a free parking space.

An advantageous design is characterized in that further items of information relating to the parking-space situation, preferably concerning residential parking zones or stopping restrictions, are transmitted by the at least one infrastructure element, and/or are provided from a digital map of the navigation device and are used for calculating the position of the at least one free parking space.

In another design, the delivery person is identified by voice recognition, by transmission of an item of identification information—PIN/TAN—or by a challenge-response method. Another design is characterized in that the system is identified by the use of an unambiguous item of cryptographic information.

In another, particularly advantageous, realization, the communication connection via the wireless communications network N2 is established via a mobile telephony communications network and/or WLAN network.

In another advantageous design, the communication between the communications means of the system and the communications means of the access arrangement and the communications means of the delivery person is encrypted by use of a common secret.

An advantage of the method according to the invention is that, by means of this method, a management of the whereabouts of the vehicles to be located, logistic synergy effects are created, since there is a high degree of automation for the transfer of the consignments to the respective vehicles. For a delivery service, the invention achieves a reduced resource requirement for the delivery time and energy consumption, with all environmentally benign secondary effects.

A further aspect of the invention is that a communication connection is established between an authorized delivery person, who obtains the corresponding authorization data from the system according to the invention, and the access device of the vehicle. When the system or the mobile terminal device of the delivery person has been successfully identified, the authorization data are updated in the control device of the access arrangement for the transfer operation by the delivery person, and are activated accordingly, such that the consignment in the trunk or in the passenger compartment is permitted for the delivery person, by the authorized, allowed opening of the vehicle doors or rear trunk lid by means of the control device, such that the consignment can be safely transferred here. According to the invention, the trunk is the place in the vehicle that is provided for transporting cargo. Generally, it is located in the rear region, but some vehicles have it at the front. In motor-vehicle engineering, the passenger compartment denotes the space occupied by the occupants of the vehicle.

Furthermore, the method, after having been initiated by the driver, may be effected in a fully automated manner by the system, i.e. rapidly and without a deployment of personnel that incurs costs. Costs are also reduced by the use of an existing mobile telephony infrastructure and the possibility of realizing this largely by means of commercially available server components. Moreover, automation minimizes the risk of incorrect inputs. A further advantage of the invention is the possibility that the updating of the authorization data can be effected directly via a mobile terminal device of the driver and of the delivery person.

The vehicle according to the invention offers a reliable and secure possibility by which a delivery person can open, for example, the trunk, but without thereby jeopardizing anti-theft security. A code-change method may be used, which may be used only in a time window, only once by the delivery person, and which expires after a single use.

The vehicle or the driver logs-in via communication connections in an infrastructure unit such as, for example, a parking garage management system, that is connected to the system according to the invention, this log-in communicating to the system according to the invention when and where the vehicle is parked, to enable a consignment to be received. In this case, advantageously, the infrastructure and the thus created information service enable the deliveries to be transferred in an optimized manner by the delivery service as a result of optimized grouping of consignments.

By the transmission of the authorization to open the vehicle concerned, it is also envisaged that, upon transmission of the authorization from the mobile terminal device of the delivery person, or the from the delivery vehicle linked thereto, all vehicles in the vicinity that are awaiting a delivery react to the radio signal, generated by the delivery person, with a light signal. This facilitates location by the delivery person, in order to rapidly find the vehicles concerned, the opening of the truck or the doors only being possible, as already mentioned, with the special individual change-code.

Further advantageous developments of the invention according to the invention for transferring perishable consignments are given by the further claims.

### BRIEF DESCRIPTION OF THE DRAWINGS

The method according to the invention is described in greater detail in the following on the basis of drawn representations, in which:

FIG. 1 schematically shows a vehicle having a communications device, and a schematic representation of an arrangement for realizing the method according to the invention,

FIG. 2 schematically shows a first exemplary embodiment of the use of the method according to the invention in a parking facility,

FIG. 3 schematically shows a schematic representation of the system of an access arrangement according to the invention,

FIG. 4 schematically shows a schematic representation of an arrangement of the method according to the invention, in which the updating is initiated via a mobile telephone, and

FIG. 5 schematically shows a schematic representation of an arrangement for realizing the system according to the invention.

### DETAILED DESCRIPTION

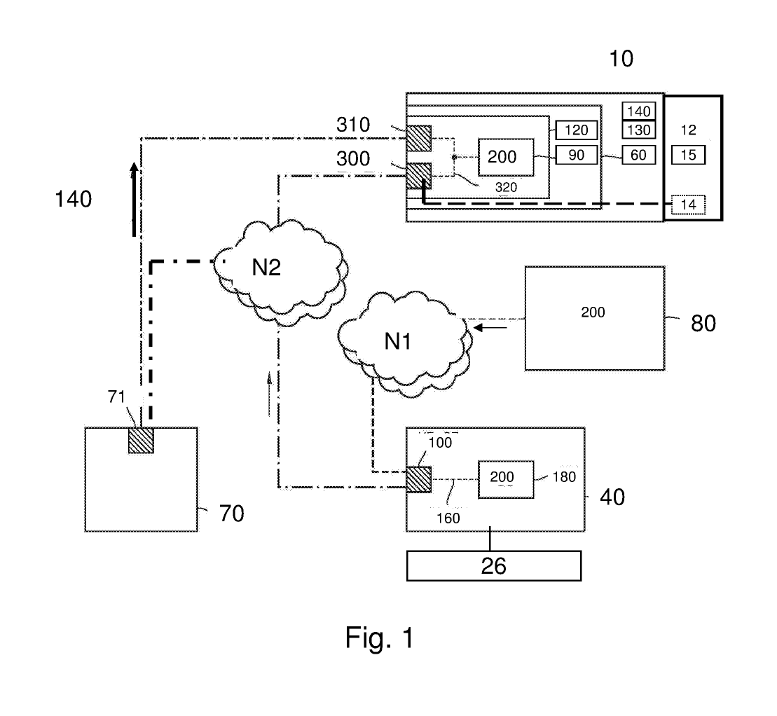

A vehicle 10 represented in FIG. 1, for example a car and/or lorry, that is to be parked in a parking space, is equipped with a positioning system, for example a GPS system 12, which includes a computing device 14 and a navigation device 15. FIG. 1 has a system 40 for transferring consignments. For this purpose, updating of authorization data 200 of an access arrangement 60 of a vehicle 10 and a communications terminal device 70 of the delivery person is performed. The system 40 may be a server-based solution, which has the usual components and peripheral such as processor, memory, network connection, operating system, application system—not represented—etc. Additionally represented are a first communications network N1 and a second communications network N2.

The communications terminal device 70 of the delivery person is, for example, a mobile telephone, a multifunctional smartphone, a chip card or a similar terminal device capable of wireless communication, having a memory and having at least one communications means 71. The system 40 has a communications means 100, via which the system 40 can communicate both with the communications network N1 and with the communications network N2. In addition, in the system 40 the communications means 100 is connected to a data module 180, via a data bus 160, by use of an appropriate communications protocol. The authorization data were originally assigned, or managed, by this data module 180 or by another competent means. The communications terminal device 80 of the driver is likewise connected, for example wirelessly, to the communications network N1.

The vehicle 10 has an access arrangement 60. This access arrangement 60 has a control device 120. This control device 120 is connected to the communications network N2 via a communications means 300. Likewise, in the control device 120, the authorization data 200 of authorized delivery persons of the access arrangement 60 are stored in a memory 90. Furthermore, has control line to an energy source 130 and to the air-conditioning system 140 in the vehicle 10.

Also represented is the mobile terminal device, or communications terminal device of the delivery person 70, which has a communications means 71. By means of this mobile terminal device, it is possible, via the communications means 71 thereof, to transmit an encoded and encrypted radio signal 140 to a communications means 310 of the control device 120 of the access arrangement 60. A radio signal is understood to be a communications signal that is based on electromagnetic signals, including optical signals (e.g. infrared light). The vehicle 10 reacts to a defined encrypted radio signal 140 of the communications terminal device 70 of the delivery person, which is preferably limited to a defined time window and which is cancelled following use of the opening command. The radio signal 140 give an access authorization, but not a driving authorization to start the vehicle. An active alarm system, not illustrated, is modified according to the invention for the period of the authorized transfer of the consignment into the vehicle 10, such that an alarm is not triggered.

Various functions of the access arrangement 60 can be triggered by means of the radio signal 140. This may be, for example, the opening or closing of the door locking or the trunk locking. In this case, particular items of information are assigned to the communications terminal device 70 of the delivery person, and particular user data 200 are assigned to the control device 120, for example by the data module 180 of the system, and are stored. These enable the access arrangement 60 of a particular vehicle 10 to be operated only with a particular communications terminal device 70 of the delivery person. The memory 90 and the communications means 300 and 310 are connected to each other via a data bus 320, using appropriate communications protocols.

Transmitted in the radio signal are data packets that may comprise, as a first data element, a vehicle identification, the vehicle color, vehicle type, vehicle registration number, a digital identification code, a call number, and may comprise, as a second data element, the vehicle position or a URL relating to a service, such as an IP-based parking-space management system 26, where the vehicle system can be interrogated, and, as a third data element, an access code, which enables a profiled access for the delivery person, but which does not give driving authorization and which becomes invalid after a certain period of time. Alternatively, other data fields are allocated, such as “search code”, “approval for door opening”, “cooling of consignment necessary after opening of vehicle”.

If the data field “cooling of consignment necessary after opening of vehicle” has been set, activation of the energy source 130 or activation of the air-conditioning system 140 can then be effected via the control device 60. The activation is dependent on the type of the perishable consignment. If, for the type of the perishable consignment, a temperature range is specified, such as, for example, 10° C.-20° C., the air-conditioning system is activated by the control device, and the perishable consignment can then be effected in the passenger compartment by access via a door.

The communications terminal device 80 of the driver, which likewise is a mobile phone, smartphone, a multifunctional car key or a chip card, contains, or receives from the vehicle 10, via the system 40, a particular number of access codes that can be used by the driver, for example, when purchasing. If the driver wishes to pay for and have something delivered, an access code of the vehicle 10, from the driver's communications terminal device 80 to a device at the checkout of the retail outlet concerned, is communicated to the system 40 via the communications network N1 or N2. The access codes in this case may have a validity period of some hours, and may no longer be used following expiry of this period.

In this variant of the issuing of authorization, the vehicle 10 need not necessarily be directly networked to the environment. The access codes prepared in the communications terminal device 80 of the driver acquire validity upon exit from the vehicle, in which the time period+X hours are defined, wherein X hours is the time period of stay in the parking space for the duration of the purchase, which is input by the driver in a predetermined manner, via a human-machine interface (HMI), not represented, of the vehicle 10, and which is then transmitted to the communications terminal device of the driver 80.

After the authorized delivery person has been unambiguously identified, the authorization data 200 are thereupon established by the communications means 100 of the system 40, via the communications network N2, a communication connection to the communications means 300 of the control device of the access arrangement 60.

The communications terminal device 70 of the delivery person is then unambiguously identified by the control device 120 of the access arrangement 60. This may be effected, for example, by the use of an unambiguous cryptographic key. It is not necessary in this case for this step to be effected immediately following the identification of the delivery person and the definition of the update request.

A possibility for the identification, or authentication, of the communications terminal device 70 of the delivery person by the control device 120 of the access arrangement 60 is, for example, a challenge/response method. In this case, it is a prerequisite that the control device 120 of the access arrangement 60 and the communications terminal device 70 of the delivery person have a common cryptographic secret. This secret is generated, expediently, upon the first log-in/registration of the driver to the system 40, either by the control device of the access arrangement 60 or by the system. The secret is then stored in the memory 90 in the control device 120 and a memory in the system. Following pick-up of the communication between the communications terminal device 70 of the delivery person and the control device SG via the communications network N2, the control device 120 will send a challenge to the system and to the communications terminal device 70 of the delivery person, from which the system and the communications terminal device 70 of the delivery person, using the cryptographic secret, calculates the response and send this back, via the communications network N2, to the control device SG of the access arrangement 60. This method, moreover, has the advantage that the subsequent, further communication between the system, communications terminal device 70 of the delivery person and the control device 120 can also be effected in an encrypted manner via the communications network N2, using the common secret, for transmitting the update request 700, and it therefore need not be a prerequisite for the protocols per se executed via the communications network N2 to have a sufficient data security.

The more simple method for identification, or authentication, of the system by the control device of the access arrangement 60 is the use of a PIN code, possibly together with a single-use TAN code. These codes, i.e. PIN and, if appropriate, a sufficient quantity of TAN codes, are expediently generated upon the first log-in/registration of the driver to the system 40, either by the control device 120 of the access arrangement 60 or by the system 40, and stored in the memory 90 of the control device 120 and in the system 40. In this case, the communication is effected without encryption, and it is a prerequisite that the protocols executed via the communications network N2 offer a sufficient data security.

Alternatively, the radio signal may be divided, between the communications terminal device 80 of the driver and the communications terminal device of the delivery person 70, in such a way that the transmitted data packets between the driver and the delivery person in the access arrangement 60, such that the data packet is transmitted partly by the driver, mobile phone or email or comparable technology, partly stored with the delivery person, and only together do the two sub-packets produce an access code, or authorization data 200. This method advantageously prevents an access code from being tapped during transmission, and the vehicle from being opened in an unauthorized manner.

In a variant of this method, no identification data are stored by the system 40 itself. Instead, following the establishment of the communication between the system and the control device 120, the system 40 transmits the identification data of the delivery person to the control device 120.

In this case, the identification data (e.g. PIN code or TAN code) are stored, on the one hand, in the memory SP of the control device 120. On the other hand, they are known to the delivery person or, for example, stored in a memory 90 in the communications terminal device 70 of the delivery person.

Following completion of unambiguous identification of the system 40 with respect to the control device 60, the update request 700 by the driver is transmitted by the communications means 100 of the system 40, via the communications network N2, to the communications means 300 of the control device 60. Updating of the authorization data 200 in the memory 90 of the control device 120 of the access arrangement 60 is then effected in accordance with the update request 700.

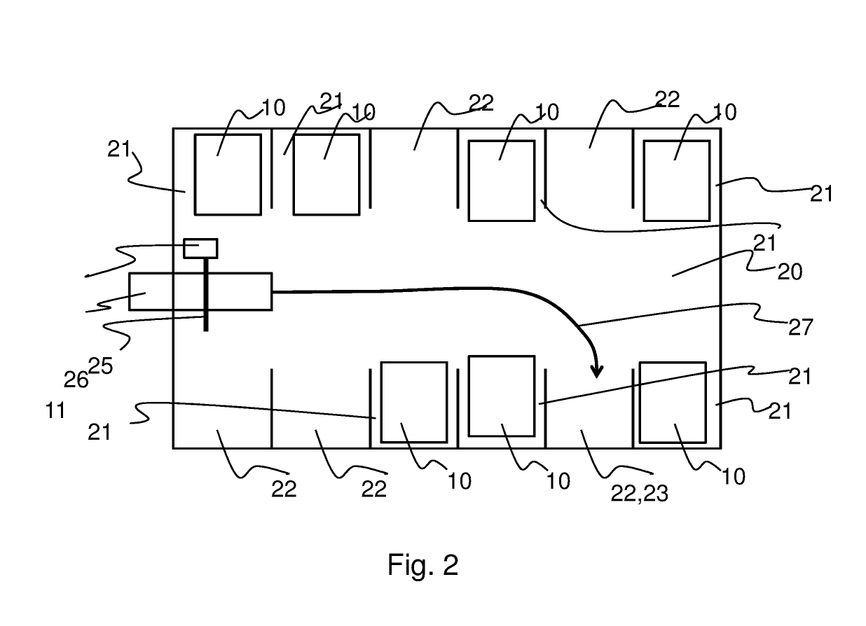

A vehicle searching for a parking space is represented in FIG. 2. When an arriving vehicle 11 searches for a parking space in a parking facility, for example in a parking garage 20 represented in FIG. 2, the vehicle is at first located at an entrance barrier 25 to the parking garage 20. The arriving vehicle 11 is equipped in a manner similar to that of the vehicle 10 represented in FIG. 1.

The parking garage 20 has parking spaces 21 that are occupied by vehicles 10. The parking spaces 22, on the other hand, are free, such that it is possible to park in them.

At the entrance barrier 25 of the parking garage 20, information about which parking spaces 22 are free is transmitted by means of short-range radio (e.g. infrared, Bluetooth, DSRC, ITS-G5, W-LAN, etc.) by the parking-space management system 26, integrated in the entrance barrier 25, to the computing device 14 of the vehicle 11, via the communication connection, i.e. by means of a vehicle-to-infrastructure communication, via the communications means 300/310. The positions of the free parking spaces 22 may be specified for example as absolute positions of the GPS system 12, or as relative positions, e.g. in relation to the position of the barrier 25.

Following the transmission of the information about free parking spaces 22, the GPS system 12 is put into the so-called parking-garage mode. On the basis of the data transmitted from the parking garage, the computing device 14 then calculates the positions of the free parking spaces 22 in the reference system of the vehicle's own GPS system 12, and displays these to the driver, on a special display created for this mode. The driver can then select a suitable parking space for his vehicle 11 and confirm the clearance of this position as a delivery location.

By means of the navigation device 15, which contains the calculated position data from the computing device 14, a route guide to a parking space 23, for example selected by the driver, can then be determined and made available to the driver. The driver in his vehicle, using the calculated route guide 27, then moves to the selected parking space 23 and parks his vehicle 11 there. The route guide is advantageous, in particular, in large, complex and busy parking facilities, for example multi-story car parks.

When the vehicle 11 is then parked in the selected parking space 23 in the parking garage, the navigation device 15 of the vehicle 11 stores its position in memory. This function may be triggered, for example, by the switch-off of the engine at the position of the selected parking space 23. The noted position of the now occupied parking space 23 is transmitted by the navigation device 15 to the memory 90, or via the communications means 300 to the system 40, to the key of the vehicle, to a mobile telephone of the driver, or to another device (e.g. chipcard0) of the driver 80 that has a preferably wireless communication capability. If required, the position of the parking space 23 may be displayed in the memory medium in the communications terminal device 80 of the driver. This enables the driver to find his vehicle 11 more rapidly upon return to the latter.

The driver then leaves the parking garage 20. At the exit, the system 26 detects, e.g. by interrogating the memory medium, which parking space the vehicle 11 is parked in. Since the memory medium has the position of the vehicle 11, or of the selected parking space 23, stored in memory, it transfers this to the parking-space management system 26 of the parking garage 20. The parking-space management system 26 then knows that the parking space 23 selected by the driver, the position of which has been transmitted to the parking-space management system 26, is occupied. The parking-space management system 26 also transmits this position to the system 40 for verification, since it is thereby checked again whether the vehicle is also located at the place where the driver parked it, as a delivery location in the confirmation.

After some time, the driver returns to the parking garage 20, in order to continue travel with his vehicle 11. Alternatively, the driver may also key in/set directly into the memory of his communications terminal device 80 the alphanumeric parking space marking, specified at the parking space, seen by the driver when parking the vehicle.

In a preferred exemplary embodiment, in the parking garage 20 there is a multiplicity of read-out points, at which the position of the vehicle 11 can be transmitted from the memory medium. Such a read-out point is located, for example, at the barrier 25 and/or at the doors and/or automated pay stations of the parking garage. Upon request by the driver, the position of the vehicle 11 and, if necessary, the way to it is displayed at such a read-out point, such that the driver his vehicle 11 can transmit the position of his parked vehicle to the delivery service, and the driver can rapidly re-find his vehicle. The position of the vehicle 11 in the parking place 23 that is stored in the navigation device 15 is preferably also used as a starting position for the next route, which is calculated by the navigation device 15. The position of the parking space 23 that has become free is transmitted by short-range radio to the parking-garage management system 26 by the memory medium or the navigation device 15 as the vehicle 11 drives out. The parking-space management system 26 now knows that the corresponding parking space 23, in which the vehicle 11 had previously parked, is now again free.

Instead of the short-range radio communication with the parking-garage management system 26, a communication may also be effected to a corresponding parking-space management server via GPS, UMTS, LTE, WiMax, W-LAN, etc.

The proposed method can be realized with a comparatively small amount of technical resource and without additional hardware in the vehicle.

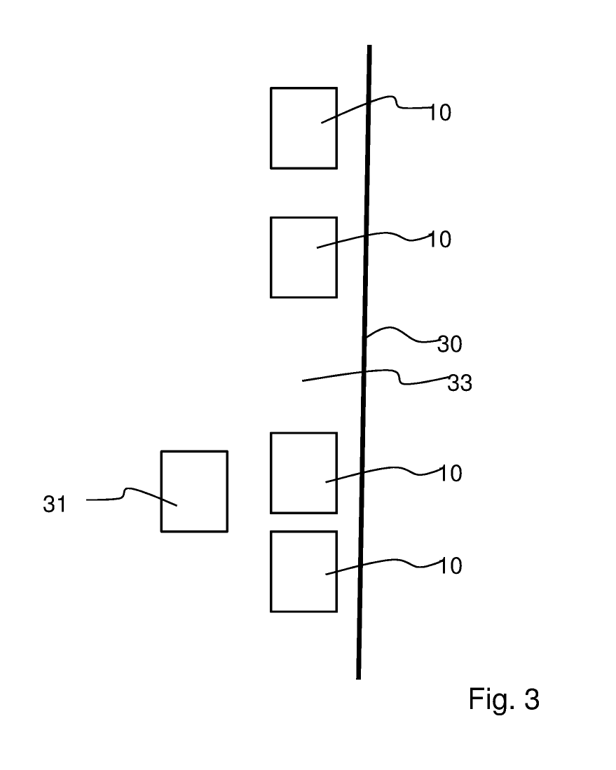

In another exemplary embodiment, represented by means of FIG. 3, it is explained how the determination of position can be effected for specifications as a delivery location in the inner-city region of large cities.

The method represented by means of FIG. 3 is used for finding parking gaps, for example at the side 30 of a road, and thus for determining a delivery location. Parked here are a plurality of vehicles 10, which correspond to the vehicle 10 represented in FIG. 1. The vehicle 31 searching for a parking place also has the same structure.

To realize the method according to the invention, it is advantageous if the vehicles 10, 31 have distance sensors, mounted at the front, rear or side of the vehicles 10, 31 concerned, such as, for example, ultrasonic sensors, infrared sensors, radar sensors, camera, etc. By means of the computing unit 14, the vehicles 10, 31 can additionally effect vehicle-to-vehicle communication and/or vehicle-to-infrastructure communication via the communications means 300/310. There is also a navigation device 15.

During the search for a parking space, the driver of the searching vehicle 31 firstly, by means of a key or a command, picks up a connection to the vehicles 10 within a surrounding area having a predefined radius around the vehicle 31. This causes the vehicles 10 already parked in the surrounding area to be “woken” out of a so-called sleep mode (inactive state) and put into the active state. The vehicles 10, now in the active state, then measure their distances from the respectively nearest vehicle 10 or from the nearest (not represented) infrastructure installation, for example a traffic light or a traffic sign, to the front, to the rear and/or to the sides.

By means of vehicle-to-vehicle communication, the determined distance data are transmitted by the vehicles 10 of the surrounding area to the computing device 14 of the vehicle 31 searching for a parking space. In addition, the positions of the respective vehicles 10 are transmitted to the computing device 14 of this vehicle 31. From the information transmitted by means of C2C communication, the computing device 14 of the GPS system 12 can then determine the respectively available space for parking. If this space is sufficiently large, the corresponding free space is identified as a parking space, and indicated to the driver as a parking space available for parking. In the case of the situation represented in FIG. 3, the parking gap 33 is such a parking space. After the vehicle 10 has occupied the parking space, this position is transmitted to the system 40, from the GPS system 12, via the communications means 300.

From the data determined by the computing device 14, the navigation device 15 can calculate the route from the current position of the vehicle 31 searching for a parking space to the free parking space 33, and make this available to the driver so that the latter can rapidly find the parking gap. If there are several free parking spaces in the area around the vehicle 31, these can be represented on a display of the computing device 14, such that the driver can select a suitable parking space.

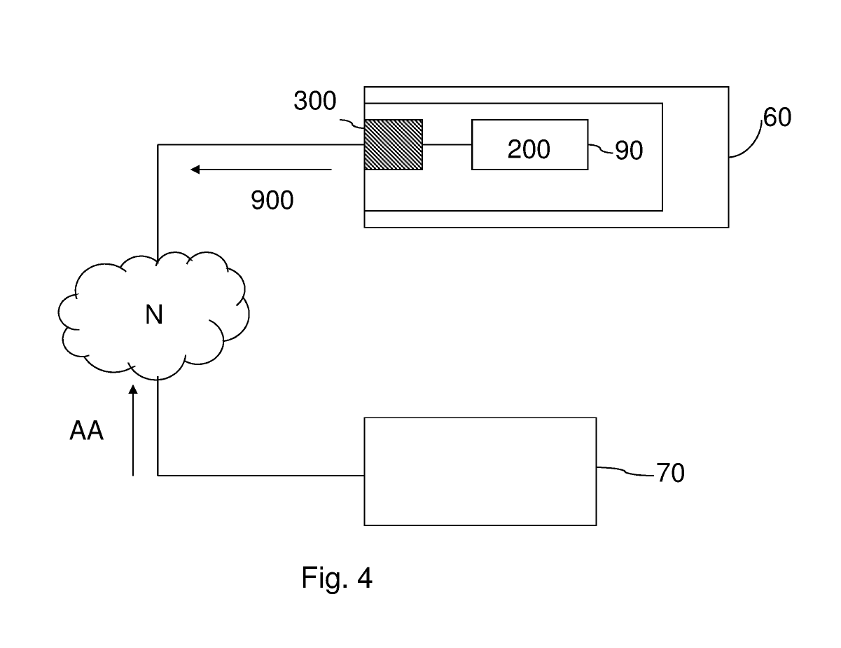

FIG. 4 shows a schematic representation of an access arrangement 60 of the method according to the invention, in which the updating of the authorization data 200 is initiated via a mobile telephone 70 of the delivery person. Also represented are a mobile telephony communications network KN, the access arrangement 60, the control device 60, the memory SP and the communications means 300 of the control device 120.

According to the invention, in this exemplary embodiment it is possible for the authorized delivery person to update the authorization data 200 of the access arrangement 60 even without the aid of a service center. For this purpose, a connection is first established, via the mobile telephony communications network N, from the mobile telephony terminal device 70 of the authorized delivery person to the communications means 300/310 of the access arrangement 60. Unambiguous identification of the authorized delivery person is then effected. This may be effected in a variety of ways. According to the invention, the control device 100 can generate an authorization code 900 and send it, via the communications means 300/310, for example as a short message—SMS—to the mobile telephony terminal device 70 of the authorized delivery person. This authorization code 900 is stored in the mobile telephony terminal device 70, in a memory or on the SIM card thereof (not represented). In the case of a required updating of the user data 200, this authorization code 900 must be sent back to the communications means 300. According to the invention, a two-part identification can then be effected. For this purpose, it is checked, firstly, whether the authorization code 900 was sent by a known mobile telephony terminal device 70, or the SIM card thereof. If this is the case, then, in a second step, the authorization code 900 sent by the mobile telephony device 70 is then checked by the control device 120 of the access arrangement 60. If the result of this check is positive, the authorization data 200 in the control device 120 are updated, e.g. erased, in accordance with the request 700.

This method for identification of the delivery person may also be secured yet further, in that the communications means of the control device 300/310, after having received the authorization code, sends an inquiry, for example as a short message—SMS—to an address (telephone number) of a mobile telephony device previously stored in the control device 120 or in the communications means of the control device 310/300, which message must then be confirmed within a time window, e.g. again by a short message with an authorization code, to the communications means of the control device 310/300.

Another possible identification method is the use of a challenge/response method, described in detail above, wherein a common secret is exchanged beforehand between the control device 120 of the access arrangement 60 and the mobile telephony terminal device 70 of the delivery person, or the SIM card thereof. In this case, the mobile telephony terminal device 70 of the delivery person must authenticate itself in respect of the access arrangement 60.

The use of the methods described above is advantageous not only for erasing user data 200 in the memory SP, but also for reactivating user data 200.

According to the invention, the methods described may also be used on RKE—remote keyless entry—keys or, also, immobilizers.

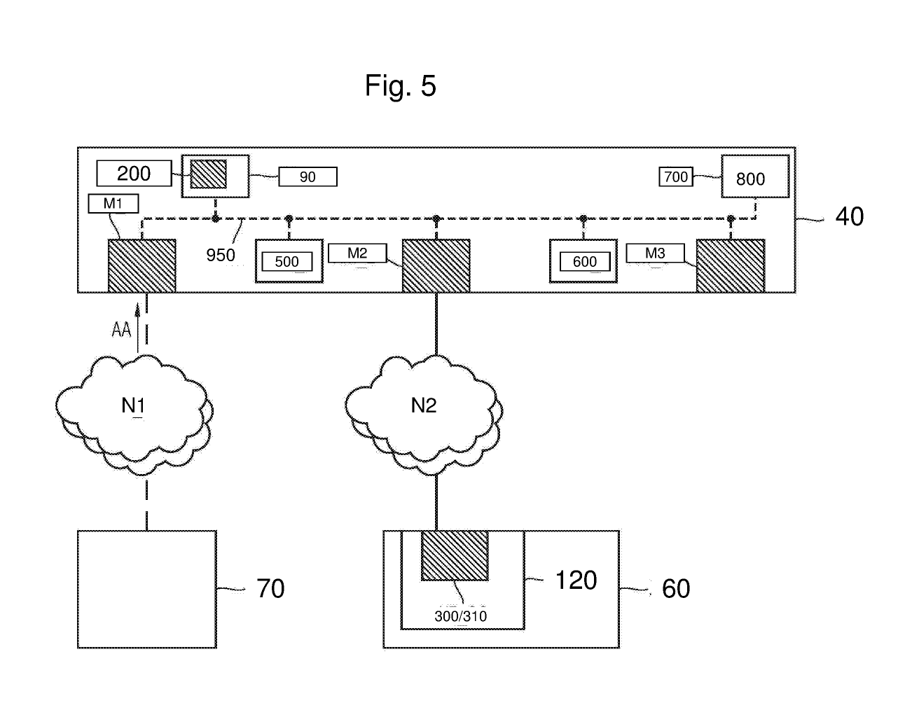

Shown schematically in FIG. 5 is a system for transferring consignments. The system has a memory 90, and authorization data 200 stored therein. The memory 90 is connected, via a data bus 950, to a first identification module, which enables a first identification routine 500.

Also connected to this data bus 950 are a second identification module and an updating module 700, which enable a second identification routine 600 and an updating routine 800. Finally, the system has at least three communications modules M1, M2 and M3. Via the first communications module 1, a communication connection can be established by the communications terminal device 70 of a delivery person, via a mobile telephony communications network N1. Via a second communications network N2, the second communications module M2 can establish a communication connection to the control device 120 of the access arrangement 60, via the communications means 300/310 thereof.

Again, according to the invention it is possible for the authorized delivery person the authorization data 200 to establish a communication connection to the system 40, via the communications means 100 thereof, by means of his communications terminal device 70, via the communications network N1. In this case, the communications network-specific protocols of the communications network N1 are used. By means of the first identification routine 500, the authorized delivery person is thereupon identified by use of one of the identification methods described above. An update request 700 is thereupon transmitted to the system by the delivery person, via the communications terminal device 70 thereof. Then, via the second communications module M2, a mobile telephony connection is established to the control device 120 of the access arrangement 60, via the communications means 300/310 thereof, via the mobile telephony communications network N2.

The system is then unambiguously identified by the control device 120. The second identification routine 600 is used for this purpose. In this case, one of the methods described above may be used for identification.

When the identification has been completed, updating of the authorization data 200 is performed, both in the control device 120 and in the memory 90 of the system. The updating routine 800 is used for this purpose. The updating in this case is effected in accordance with the update request 700 by the authorized delivery person.

Neither the method according to the invention nor the arrangement according to the invention are limited to the exemplary embodiments, but may be used in all access arrangement, e.g. for buildings or items of electrical equipment that have communications means for communication via communications networks. The communications means in this case must be matched to the communications networks and identification methods used.

1. A method for transferring perishable consignments into vehicles, the method comprising:
determination of the position of a vehicle, by means of a positioning system in the vehicle,
clearance of a position of the parked vehicle, as a delivery address, to a system, via a communications unit of the vehicle, via a communications network,
transmission of the position of the parked vehicle, via a communications unit of a control device of the access arrangement, via a communications network (N2),
transmission of the authorization clearance for opening at least one door and/or trunk of the vehicle by a person delivering a consignment, via a communications means of a system, via a communications network (N1), to the communications terminal device of the person delivering a consignment, and the radio signal contains the authorization clearance, wherein the opening is valid within a defined time window,
transmission of a radio signal, which contains an authorization clearance, wherein, upon authorization being present, the access arrangement activates opening of at least one door and/or trunk of the vehicle,
after opening and transferral of the consignment have been completed by the manual closing of a door and/or trunk of the vehicle by the delivery person, that a confirmation of the transferral of the consignment by the delivery person is effected via the communications means, via the communications network (N2), to the communications terminal device of the driver of the vehicle via the system, and
following transmission of an update request by the communications means of the driver of the vehicle, an update of authorization data is effected in the control device of the access arrangement,
characterized in that, upon the clearance of the position of the vehicle, by the driver, as a delivery address, it was specified by the driver and/or delivery person what type of perishable consignment in the vehicle is to be delivered and, following opening and transferral of the perishable consignment into the trunk, an energy source in the vehicle, which is suitable for supplying a refrigeration unit, in which the perishable consignment is delivered, is activated, if the delivered consignment is a perishable consignment, that is to be cooled in a low temperature range, which was specified previously, upon the clearance of the position of the vehicle as a delivery address, by the driver, and it is determined, by checking of the vehicle type, whether such an energy source is present in the vehicle.

2. The method as claimed in claim 1, characterized in that the activation of the energy source is triggered via a control device of the access arrangement.

3. The method as claimed in claim 2, characterized in that, upon the actuation of the energy source via the control device of the access arrangement, a switching is effected to check the energy capacity and, in the case of a value below a minimum energy capacity value that is necessary, at least, for starting the vehicle, the energy source is switched off, and the driver receives a message, by the vehicle-driver communications means, concerning the switch-off of the energy source.

4. The method as claimed in claim 3, characterized in that it is ascertained, in the checking of the vehicle type, what quantity of energy there is in the vehicle.

5. The method as claimed in claim 4, characterized in that it is ascertained whether the vehicle is connected to an external energy source.

6. The method as claimed in claim 5, characterized in that the position of the free parking space is transmitted to the navigation device when the vehicle is located in a previously defined region in relation to the free parking space and in proximity of a barrier of a parking facility.

7. The method as claimed in claim 6, characterized in that, following parking of the vehicle in a selected free parking space, the position of the selected parking space is transmitted to a memory medium that preferably can be transported by the driver, preferably to a key of the vehicle and/or to a mobile telephone of the driver and/or to a chip card, then stored, and preferably additionally displayed, on the memory medium.

8. The method as claimed in claim 7, characterized in that the navigation device or the memory medium transmits the position of the selected parking space to a parking-space management system of the parking facility.

9. The method as claimed in claim 8, characterized in that, upon departure from the selected parking space, the position of the parking space that is now free again is transmitted to the system via the parking-space management system of the parking facility.

10. The method as claimed in claim 9, characterized in that the position of the at least one free parking space is calculated from a measurement of distance, of at least one vehicle or at least one infrastructure element in relation to other vehicles or in relation to other infrastructure elements, that are disposed within a surrounding area having a predefined radius around the vehicle searching for a free parking space.

11. The method as claimed in claim 10, characterized in that further items of information relating to the parking-space situation, preferably concerning residential parking zones or stopping restrictions, are transmitted by the at least one infrastructure element, and/or are provided from a digital map of the navigation device and are used for calculating the position of the at least one free parking space.

12. The method as claimed in claim 11, characterized in that the delivery person is identified by voice recognition, by transmission of an item of identification information—PIN/TAN—or by a challenge-response method.

13. The method as claimed in claim 12, characterized in that the system is identified by the use of an unambiguous item of cryptographic information.

14. The method as claimed in claim 13, characterized in that the communication connection via the wireless communications network (N2) is established via a mobile telephony communications network and/or WLAN network.

15. The method as claimed in claim 14, characterized in that the communication between the communications modules (M1, M2, M3) of the system and the communications means of the control device of the access arrangement and the communications terminal device of the delivery person is encrypted by use of a common secret.
